(19) United States
(12) Patent Application Publication
(10) Pub. No.: US 2024/0218856 A1
(43) Pub. Date: Jul. 4, 2024

(54) FORCE MEASUREMENT APPARATUS FOR PILE

(71) Applicant: Industrial Technology Research Institute, Hsinchu (TW)

(72) Inventors: Yu-Hsuan Shih, Kaohsiung City (TW); Che-Kai Yeh, Tainan City (TW); Tzung-Ching Lee, Hsinchu County (TW); Chao-Ta Huang, Hsinchu City (TW)

(73) Assignee: Industrial Technology Research Institute, Hsinchu (TW)

(21) Appl. No.: 18/306,999

(22) Filed: Apr. 25, 2023

(30) Foreign Application Priority Data
Jan. 4, 2023 (TW) 112100180

(51) Int. Cl. F03D 17/00; G01M 5/00

(52) U.S. Cl. CPC F03D 17/00; G01M 5/0058; G01B 7/18

(57) ABSTRACT

A force measurement apparatus adapted to be installed on a pile includes at least one pressing ring and a plurality of force sensors. The pressing ring includes a ring body and at least one pressing part. The ring body has at least one end and an inner surface facing the pile. The pressing part is disposed at the end. The force sensor is disposed between the inner surface of the ring body and the pile so as to sense a radial deformation and the degree of eccentricity of the pile.

### CROSS-REFERENCE TO RELATED APPLICATION

This application claims the priority benefit of Taiwan application serial no. 112100180, filed on Jan. 4, 2023. The entirety of the above-mentioned patent application is hereby incorporated by reference herein and made a part of this specification.

### TECHNICAL FIELD

The disclosure relates to a measurement apparatus, and relates to a force measurement apparatus suitable for piles.

### BACKGROUND

Wind power generation is one of the current alternative energy sources. Taking wind power generation as an example, wind turbines installed along the coast or offshore wind turbines installed in the sea may convert sea breeze into electrical energy. The manufacturing costs of these wind turbines are expensive. And wind turbines require high maintenance costs after installation, because the installed pile needs to be able to resist the harsh environmental stress of nature (such as storm wind, large waves, earthquake and soil pressure, etc.).

In addition, during piling process of the wind turbine, it is necessary to install a force measurement apparatus on the wind turbine to measure the impact force on the pile in real time, and to detect the degree of eccentricity of the pile (the radical displacement of the pile relative to the axis) caused by the impact force of a pile driver in real time.

At present, before the existing sensor is installed for detecting the force applied to the pile, it is necessary to carry out destructive installation steps such as drilling or digging out cracks in the pile, in which the force sensors are embedded by means of expansion screws or glue. However, this method will induce stress concentration at the drill hole of the pile and increase the risk of pile cracking. In addition, the force sensor of the conventional pile is embedded in the hole or crack of the pile, so it is difficult to maintain.

Furthermore, in the process of piling, when the axis of the pile driving equipment deviates from the axis of the pile (eccentricity), the pile with the force sensor installed by the destructive manner will increase the chance of cracking due to non-uniform force.

Although in the prior art, the reduced-scale pile may be used for piling test, so as to be able to correct the control parameters of the pile driving equipment through the piling test of the reduced-scale pile. However, there are too many factors that will affect the quality of piling process in the practical application of the wind turbine, so it is impossible to accurately correct the control parameters of the pile driving equipment by reduced-scale pile test. Moreover, the existing piling technology of reduced-scale pile does not provide the real-time feedback of the dynamic force of piling, and cannot determine whether the pile is offset or not, so the control parameters of pile driving equipment cannot be corrected in real time with the existing piling technology.

Furthermore, the existing sensor arrangement does not allow eccentric measurement of the piling force.

It may be seen from the above that the external working environment of onshore wind turbines or offshore wind turbines is quite harsh. At present, there is no suitable force measurement apparatus that may detect the state of the wind turbine under various external forces in real time, thus the operation cost, maintenance cost and the difficulty of management are increased.

### SUMMARY

The force measurement apparatus of the disclosure is adapted to sense a radial deformation of a pile. The force measurement apparatus includes at least one pressing ring and at least one force sensors. The pressing ring includes a ring body and at least one pressing part. The ring body has at least one end and an inner surface, in which the ring body surrounds an axis passing through a centroid of the ring body, and the inner surface faces the pile. The pressing part is disposed at the end. The force sensor is disposed on the inner surface of the ring body so as to sense the radial deformation of the pile.

The force measurement apparatus of the disclosure is adapted to sense a radial deformation of a pile, and the force measurement apparatus includes at least one pressing ring, at least one force sensor, and a force sensing element. The pressing ring includes a ring body, and at least one pressing part. The ring body has at least one end and an inner surface, in which the ring body surrounds an axis passing through a centroid of the ring body, and the inner surface faces the pile. The pressing part is disposed at the end. The force sensor includes a connection part and a contact part, in which the connection part is connected to the inner surface of the ring body, and the contact part having a convex surface facing the pile is connected with the connection part to form a space; and the pressing part is capable of pressing the ring body such that the convex surface contacts the pile to fix the force measurement apparatus on the pile. The force sensing element is disposed in the space to sense the radial deformation of the pile.

The force measurement apparatus of that disclosure is adapted to sense a radial deformation of a pile, and the force measurement apparatus includes at least one pressing ring, at least one force sensor, and a force sensing element. The pressing ring includes two arc-shaped structures and a plurality of pressing parts. Each of the arc-shaped structures has two ends and an inner surface facing the pile, in which the two arc-shaped structures surround an axis passing through a centroid of the two arc-shaped structures, and the ends are connected with the pressing parts one by one. Each of the force sensors includes a connection part and a contact part, in which the connection part is connected to the inner surface of the ring body, and the contact part having a convex surface facing the pile is connected to the connection part and forms a space with the connection part, and a radial stiffness of the contact part is smaller than a radial stiffness of each of the arc-shaped structures. The force sensing element is disposed in the space, in which the pressing parts are capable of pressing the arc-shaped structures such that the convex surface contacts the pile to fix the force measurement apparatus on the pile for sensing the radial deformation of the pile, a region where the convex surface contacts the pile is a plane or a line.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram of a force measurement apparatus of a first embodiment of the disclosure installed on a pile.

FIG. 2 is a schematic diagram of the force measurement apparatus of FIG. 1.

FIG. 3 is a cross-sectional diagram taken along a line A-A′ in FIG. 1.

FIG. 4 is a schematic diagram of a force sensing element.

FIG. 5 is a schematic diagram of pile eccentricity analysis.

FIG. 6A is a schematic diagram of the deformation of the pile in FIG. 3 after a force is applied.

FIG. 6B is a schematic diagram of radial deformation measured by the force sensor after the deformation of the pile.

FIG. 7 is a schematic diagram of a force measurement apparatus according to a second embodiment of the disclosure.

### DETAILED DESCRIPTION OF DISCLOSURED EMBODIMENTS

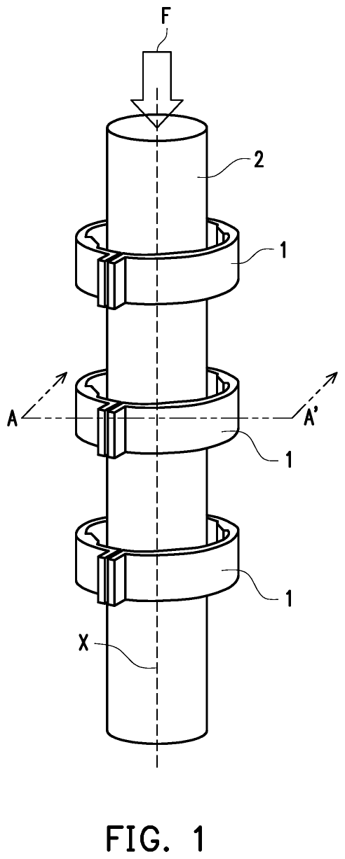

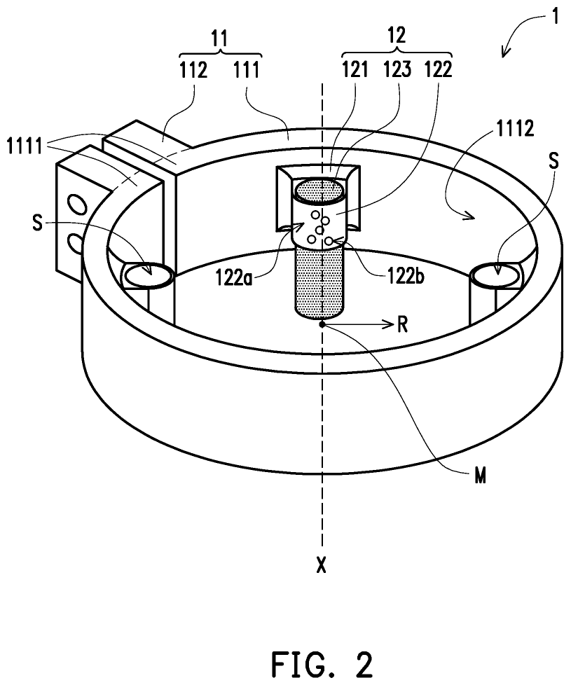

FIG. 1 is a schematic diagram of a force measurement apparatus of a first embodiment of the disclosure installed on a pile, while FIG. 2 is a schematic diagram of the force measurement apparatus of FIG. 1. Referring to FIG. 1 and FIG. 2 at the same time, a force measurement apparatus 1 of this embodiment is installed on a pile 2 (such as the pile of a wind turbine) and is adapted to sense the radial deformation (or radial strain) of the pile 2. The radial deformation (or radial strain) of the pile 2 described in this specification is the deformation (or strain) of the pile 2 along a radial direction R. The radial deformation (or radial strain) at least includes the radial deformation of the pile 2 when the pile 2 is subjected to an axial force F along an axial direction X or the radial deformation of the pile 2 when the pile 2 is subjected to an eccentric force along an axial direction X. A plurality of force measurement apparatus 1 may be installed on the pile 2, and these force measurement apparatuses 1 may be installed at equal intervals along the axial direction X of the pile 2 (as shown in FIG. 1), or installed at specific positions of the pile 2 according to the purpose of measurement. The pile 2 includes a solid pile body (such as a circular solid cylinder, a rectangular solid cylinder, or a polygonal solid cylinder) or a hollow pile body (such as a circular tubular body, a rectangular tubular body, or a polygonal tubular body). In this disclosure, a force measurement apparatus installed on the pile in a non-destructive manner is provided.

The force measurement apparatus 1 includes at least one pressing ring 11 and a plurality of force sensors 12. The pressing ring 11 includes a ring body 111 and at least one pressing part 112. The ring body 111 has at least one end 1111 and an inner surface 1112, wherein the ring body 111 surrounds the axis X passing through a centroid M of the ring body 111. The pressing part 112 is disposed at the end 1111 of the ring body 111, and the inner surface 1112 of the ring body 111 faces the pile 2 in the radial direction. The force sensor 12 is disposed on the inner surface 1112 of the ring body 111. When the force measurement apparatus 1 is installed on the pile 2, the pressing part 112 may press the ring body 111, such that the plurality of force sensors 12 directly contact the pile 2 to fix the force sensors 12 on the pile 2. The plurality of force sensors 12 fixed on the pile 2 may sense the radial deformation of the pile 2 when the pile 2 is subjected to the axial force F. The sensed radial deformation of the pile 2 can be used to calculate the radial strain according to a radius r of the pile 2. For example, when the pile 2 with the radius r is subjected to an axial force and a radial deformation Ar is induced in the radial direction R, the radial strain may be calculated by Δr/r.

In this embodiment, the ring body 111 is a C-shaped ring, and the ring body 111 has two ends 1111, wherein each end 1111 is connected with a corresponding pressing part 112. Two pressing parts 112 may be physically joined, for example, by means of a fastener (such as screws). The method of joining the two pressing parts 112 is not limited to the example of this embodiment, but may be selected according to actual requirements.

The inner diameter of the ring body 111 may be changed by joining the two pressing parts 112 tightly, such that the force sensor 12 installed on the inner surface 1112 of the ring body 111 contacts outer surface of the pile 2 to fix the force sensor 12 on the pile 2.

In this embodiment, a plurality of force sensors 12 (for example, four force sensors) are provided. The four force sensors 12 are disposed on the inner surface 1112 of the ring body 111 along the circumferential surface of the ring body 111 and are disposed axisymmetrically with respect to the axis X.

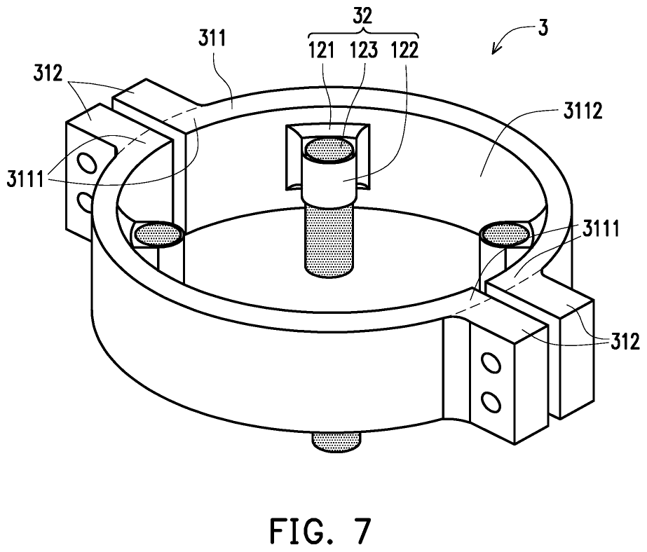

Each of the force sensors 12 includes a connection part 121, a contact part 122, and a force sensing element 123. The connection part 121 is connected to the inner surface 1112 of the ring body 111. The contact part 122 is connected to the connection part 121 and to form a space S, wherein the force sensing element 123 is disposed in this space S. Incidentally, in order to clearly indicate the space S, one force sensor 12 with one force sensing element 123 is shown in FIG. 2. In another embodiment, the four force sensing elements 123 are disposed in four spaces respectively and are shown in FIG. 7.

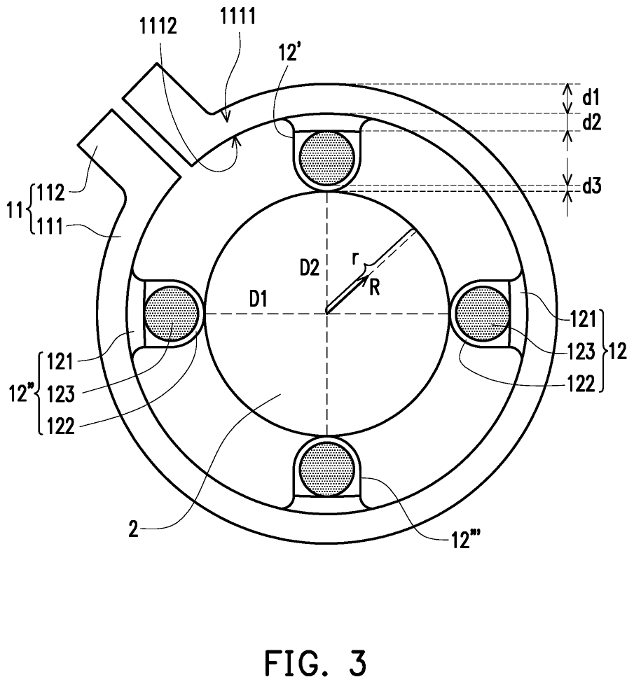

FIG. 3 is a cross-sectional diagram taken along a line A-A′ in FIG. 1. Referring to FIG. 3, in this embodiment, a radial dimension d3 of the contact part 122 is smaller than a radial dimension d1 of the ring body 111, a radial dimension d2 of the connection part 121 is smaller than the radial dimension d1 of the ring body 111. The radial dimension d3 of the contact part 122 is smaller than the radial dimension d2 of the connection part 121.

The radial dimension refers to the dimension along the radial direction R of the ring body 111. Alternatively, it may be understood as referring to the thickness of these elements. In other words, the thickness of the ring body 111 is larger than the thickness of the connection part 121 and the thickness of the connection part 121 is larger than the thickness of the contact part 122.

Among the radial dimension d1 of the ring body 111, radial dimension d2 of the connection part 121 and the radial dimension d3 of the contact part 122, the radial dimension d1 of the ring body 111 is largest in order to provide sufficient structural strength of the force measurement apparatus 1 and to provide the largest radial stiffness for the ring body 111 such that the ring body 111 can serve as a stationary part of the plurality of force sensors 12. Therefore, when one force sensor 12 is subjected to a force component such as a radial force, the ring body 111 will not have a large radial deformation that affects the measurement accuracy of another force sensor 12. In other words, when the ring body 111 has the largest radial dimension d1 or the largest radial stiffness, coupled effect between the force sensors 12 can be prevented. Thus, when one of the force sensors 12 measures a radial force, it will not be affected by the deformation induced by another force sensors 12.

The radial dimension d2 of the connection part 121 is between the radial dimension d1 of the ring body 111 and the radial dimension d3 of the contact part 122, such that the connection part 121 may provide sufficient strength to support the force sensing element 123 disposed in the space S. Moreover, since the radial dimension d2 of the connection part 121 is larger than the radial dimension d3 of the contact part 122, the radial stiffness of the connection part 121 is larger than the radial stiffness of the contact part 122. Therefore, when the force sensor 12 is subjected to a radial force, the radial deformation of the contact part 122 in the space between the ring body 111 and the pile 2 is larger than the radial deformation of the connection part 121 in the space between the ring body 111 and the pile 2. Therefore, the force sensor 12 will have a wider measuring range when the force sensor 12 is subjected to a radial force since the space between the ring body 111 and the pile 2 is limited by the ring body 111 and the pile 2 and the total radial deformation of the force sensor 12 equals the sum of the radial deformation of the connection part 121 and the radial deformation of the contact part 122.

The radial dimension d3 of the contact part 122 is the smallest, in order to make the contact part 122 have the smallest radial stiffness. As a result, when the force sensor 12 is subjected to a radial force of the pile 2, the contact part 122 will have the largest radial deformation, and then press the force sensing element 123 in the space S to generate a maximum electrical signal (e.g. voltage signal). In other words, when the radial dimension d3 of the contact part 122 is the smallest, the measurement sensitivity of the force sensor 12 can be enhanced.

However, in another embodiment, the ring body 111, the connection part 121 and the contact part 122 may be made of different materials, such that the ring body 111 has the maximum radical stiffness and the contact part 122 has the minimum radical stiffness to make measuring range wider and to enhance the measurement sensitivity.

The contact part 122 further has a convex surface 122a that faces the pile 2 in radical direction and may contact the pile 2, wherein a region where the convex surface 122a contacts the pile 2 may be a plane or a line. That is, a plane of the convex surface 122a or a line of the convex surface 122a may contact the pile 2 in radical direction. On the other hand, for the convex surface 122a, the shape of the convex surface 122a may be designed according to different design requirements. Moreover, the convex surface 122a has an embossed pattern 122b to increase the surface friction when contacting with the pile 2. When the force sensor 12 is installed on the pile 2, the surface friction can prevent the convex surface 122a from being too smooth to fix the force sensor 12 on the pile 2 or prevent the force sensor 12 from slipping on the pile 2. The embossed pattern 122b may have different designs according to the requirements of surface friction. For example, the embossed pattern 122b may be a plurality of bumps or a plurality of specific patterns.

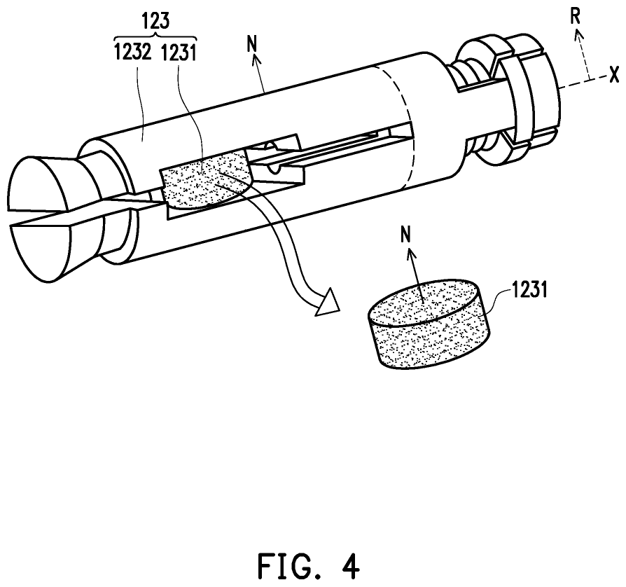

FIG. 4 is a schematic diagram of the force sensing element 123. Referring to FIG. 1, FIG. 2 and FIG. 4 at the same time, the force sensing element 123 is a piezoelectric sensing element, and the piezoelectric sensing element includes a piezoelectric sheet 1231 and a housing 1232. When the force sensing element 123 is disposed in the space S formed by the contact part 122 and the connection part 121, a normal vector N of the piezoelectric sheet 1231 faces the pile 2. That is, the normal vector N of the piezoelectric sheet 1231 is perpendicular to the axial direction X of the pile 2 and parallel to the radial direction R of the pile 2. In this way, when the piezoelectric sheet 1231 is pressed by the pile 2, the force sensing element 123 may generate the maximum electrical signal (e.g. voltage signal). The electrical signal may be configured to calculate the radial deformation or radial strain of the pile 2 or the radial force.

The force measurement apparatus 1 is installed on the pile 2 by pressing the pressing part 112 of the ring body 111 to make the contact part 122 of the force sensor 12 contact the pile 2, such that the whole force measurement apparatus 1 is fixed on the pile 2. The force sensing element 123 disposed in the space S formed by the contact part 122 and the connection part 121 is sandwiched between the pile 2 and the ring body 111.

At this time, a plurality of force sensing elements 123 sandwiched between the pile 2 and the ring body 111 may measure mechanical quantities such as a plurality of radial deformations or a plurality of radial strains of the pile 2 at a plurality of positions. After these mechanical quantities are retrieved to a control center, the dynamic force during piling and the degree of eccentricity of the pile 2 may be analyzed. In this way, during piling process on the ground, piling equipment operators may adjust a variety of equipment parameters according to the above analyzed results in real time.

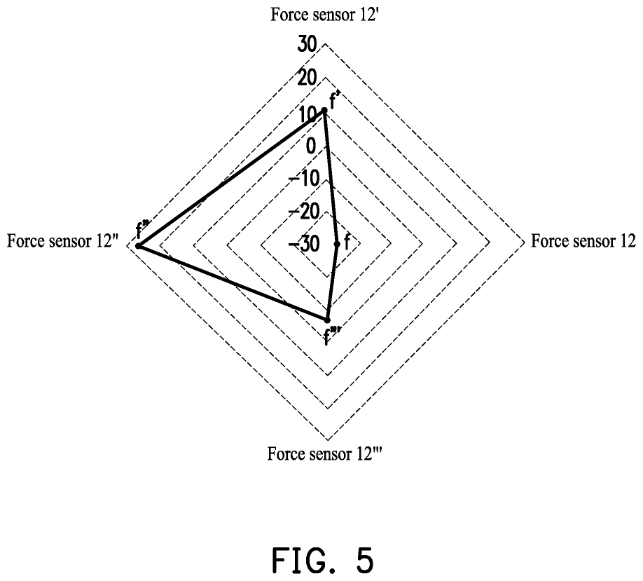

FIG. 5 is a schematic diagram of eccentricity analysis of the pile 2. In FIG. 5, the force sensor 12 and a force sensor 12″ are axisymmetrically disposed and a force sensor 12′ and a force sensor 12′″ are also axisymmetrically disposed. However, it may be seen from FIG. 5 that a force f sensed by the force sensor 12 is not the same as a force f “sensed by the force sensor 12”. Also, a force f′ sensed by the force sensor 12′ is different from a force f′″ sensed by the force sensor 12′″. This means that the loading condition on the pile 2 has become eccentric during piling. At this time, the pile 2 will be obliquely driven into a pile receiving surface (for example, the surface of soil). After the eccentricity of the pile 2 is detected by the force measurement apparatus 1 installed on the pile 2, the piling equipment operator may adjust the inclination angle of the pile 2 or adjust the control parameters of the pile driving equipment (for example, piling angle, piling force, etc.) in real time, so as to prevent the pile 2 from being obliquely driven into the ground or rock under the sea.

In addition to measuring the eccentricity of the pile 2 during piling, the force measurement apparatus 1 of the disclosure may also measure the radial deformation of the pile 2.

During piling, the pile driving equipment applies force F (shown in FIG. 1) to one end of the pile 2 along the axial direction X and the pile receiving surface applies an reaction force to another end of the pile 2 along the axial direction X at the same time. Hence, the radial deformation of the pile 2 is generated.

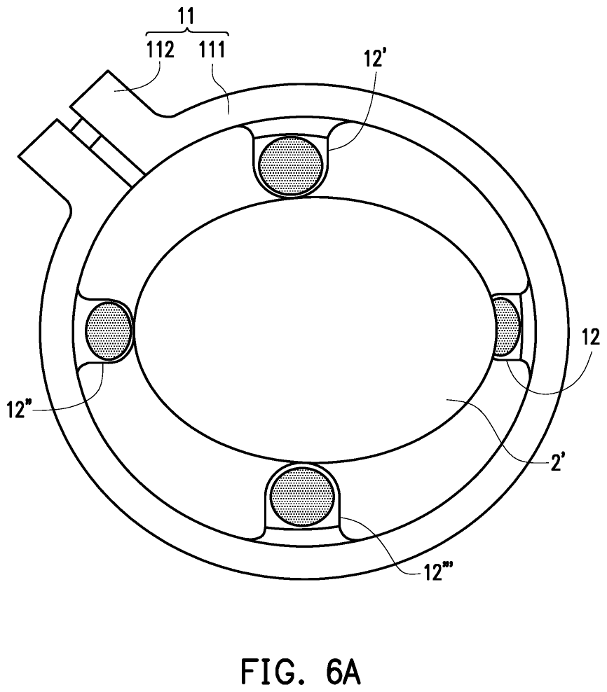

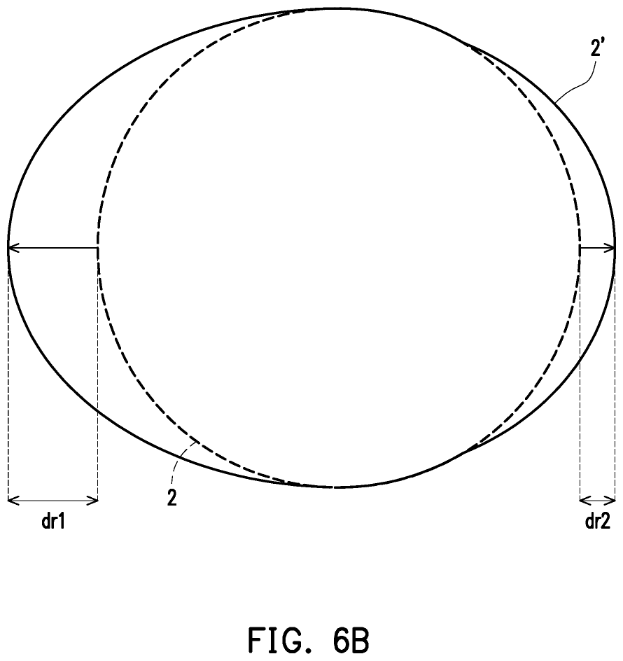

FIG. 6A is a schematic diagram of the deformed pile 2′ and the deformed sensors in FIG. 3. FIG. 6B is a schematic diagram of radial deformation of the pile which is measured by the force sensor. Referring to FIGS. 3, 6A, 6B, the pile 2′ is deformed along the radial direction. As shown in FIG. 3, through the plurality of force sensors 12, 12′, 12″, 12′″ symmetrically disposed along the ring body 111, it is possible to determine whether the measured deformations of the corresponding two force sensors 12 and 12″ (or 12′ and 12′″) are substantially the same. In FIG. 3, the corresponding two force sensors 12, 12″ are disposed at two ends of one diameter D1 of the ring body 111 and the other two force sensors 12′, 12′″ are disposed at two ends of the other diameter D2 of the ring body 111. In other words, the force sensors 12, 12″ are axisymmetrically disposed on the inner surface 1112 of the ring body 111, and the force sensors 12′, 12′″ are also axisymmetrically disposed on the inner surface 1112 of the ring body 111.

As shown in FIG. 6B, a radial deformation dr1 measured by the force sensor 12″ on the left side is larger than a radial deformation dr2 measured by another force sensor 12 on the right side. After the two radial deformations dr1 and dr2 are retrieved to the control center, the degree of eccentricity of the pile 2 may be analyzed. The piling equipment operator may adjust the equipment parameters (such as piling force, piling angle, etc.) of the pile driving equipment according to the degree of eccentricity of the pile 2, so as to correctly complete the piling process.

The force measurement apparatus of the disclosure is fixed on the periphery of the pile 2 by means of pressing and contacting. In other words, according to the disclosure, the force measurement apparatus 1 may be installed on the pile 2 without drilling any hole on the pile. Therefore, after the force measurement apparatus 1 is installed on the pile 2, the structural strength of the pile can still be maintained to avoid the stress concentration on pile and risk of pile cracking.

Moreover, the force measurement apparatus 1 of the disclosure has a simple structure, and the force measurement apparatus 1 is fixed on the pile 2 by means of pressing and contacting. Therefore, the force measurement apparatus 1 of the disclosure is easy to install, uninstall and reinstall on different piles 2, thus cost of piling engineering can be reduced. Furthermore, the force measurement apparatus 1 may be configured to measure the radial deformation or radial strain at the axisymmetric positions of the pile, such that the degree of eccentricity of the pile may be determined during piling. It is an effective function that the conventional force measurement apparatus cannot possess during piling.

FIG. 7 is a schematic diagram of a force measurement apparatus according to a second embodiment of the disclosure. Referring to FIG. 2 and FIG. 7 at the same time, the difference between this embodiment and the first embodiment is that a ring body 311 in this embodiment is composed of two arc-shaped structures and one pressing part 312 is disposed on each end 3111 of each arc-shaped structure.

As shown in FIG. 7, in this embodiment, the ring body 311 is composed of two arc-shaped structures, and one pressing part 312 is disposed on each end 3111 of each arc-shaped structure. In the first embodiment with a C-shaped ring, only one end 112 of the ring body 111 can be pressed to joint another end 112 of the ring body. In this embodiment, pressure may be applied on two ends 312 of the ring body 311 to joint another two ends 312 of the ring body 311. Therefore, a force measurement apparatus 3 applies a more uniform contact force on the pile 2 (shown in FIG. 1), such that a plurality of force sensors 32 are subjected to an uniform pre-load. When the plurality of force sensors 32 are subjected to the uniform pre-load, the accuracy of the force measurement apparatus 3 in analyzing the degree of eccentricity of the pile 2 (shown in FIG. 2) can be improved.

Incidentally, although the first embodiment and the second embodiment have been described with the example that four force sensors 12, 32 are disposed on the inner surfaces 1112, 3112 of the ring bodies 111, 311, the number of force sensors 12, 32 in the disclosure is not limited to the aforementioned embodiments. According to the requirement of eccentricity measurement of the pile 2, at least one force sensors 12, 32 may be disposed. When the number of force sensors 12, 32 is two or more force sensors 12, 32 are disposed and the force sensors 12, 32 are axisymmetrically disposed along the circumference of the ring bodies 111, 311, the degree of eccentricity of the pile 2 can be accurately measured.

In summary, the disclosure provides a force measurement apparatus with a novel architecture. The force measurement apparatus is provided with at least one force sensors, and the force sensors may directly contact the pile such that the force measurement apparatus is installed on the pile. On the contrary, the conventional force sensor may be installed on the pile by a through hole drilled on the pile. According to the force measurement apparatus of the disclosure, there is no need to drill a hole on the pile, which not only maintains the strength of the pile, but also avoids the risk of the pile cracking due to stress concentration at the drilled holes.

In addition, although the force measurement apparatus of the disclosure has simple components, it is easy to operate, and may be easily installed on the pile or uninstalled from the pile. Therefore, the force measurement apparatus of the disclosure may be repeatedly used in different piles, thus reducing the engineering cost during piling.

Furthermore, a plurality of force sensors of the force measurement apparatus of the disclosure is axisymmetrically disposed on the circumference of the pile, such that the degree of eccentricity and radial deformation of the pile may be measured during piling, which is an effective function that cannot be possessed by the conventional force sensors disposed in the drilled holes through the pile.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A force measurement apparatus, adapted to sense a radial deformation of a pile, comprising:
at least one pressing ring comprising:
a ring body with at least one end and an inner surface, wherein the ring body surrounds an axis passing through a centroid of the ring body, the inner surface faces the pile; and
at least one pressing part disposed at the at least one end; and
at least one force sensor disposed on the inner surface of the ring body to sense the radial deformation of the pile.

2. The force measurement apparatus, adapted to sense a radial deformation of a pile, according to claim 1, wherein the at least one pressing part is capable of pressing the ring body such that the at least one force sensor contacts the pile to fix the at least one force sensor on the pile.

3. The force measurement apparatus, adapted to sense a radial deformation of a pile, according to claim 2, wherein the at least one force sensor comprises:
a connection part connected to the inner surface of the ring body;
a contact part connected with the connection part to form a space, wherein the at least one pressing part is capable of pressing the ring body such that the contact part contacts the pile; and
a force sensing element disposed in the space so as to sense the radial deformation of the pile.

4. The force measurement apparatus, adapted to sense a radial deformation of a pile, according to claim 1, wherein a radial stiffness of the force sensor is smaller than a radial stiffness of the ring body.

5. The force measurement apparatus, adapted to sense a radial deformation of a pile, according to claim 4, wherein a radial stiffness of the contact part is smaller than the radial stiffness of the ring body.

6. The force measurement apparatus, adapted to sense a radial deformation of a pile, according to claim 5, wherein a radial stiffness of the connection part is smaller than the radial stiffness of the ring body.

7. The force measurement apparatus, adapted to sense a radial deformation of a pile, according to claim 6, wherein the radial stiffness of the contact part is smaller than the radial stiffness of the connection part.

8. The force measurement apparatus, adapted to sense a radial deformation of a pile, according to claim 3, wherein the contact part has a convex surface facing the pile to contact the pile.

9. The force measurement apparatus, adapted to sense a radial deformation of a pile, according to claim 8, wherein a region where the convex surface contacts the pile is a plane.

10. The force measurement apparatus, adapted to sense a radial deformation of a pile, according to claim 8, wherein a region where the convex surface contacts the pile is a line.

11. The force measurement apparatus, adapted to sense a radial deformation of a pile, according to claim 8, wherein the convex surface has an embossed pattern.

12. The force measurement apparatus, adapted to sense a radial deformation of a pile, according to claim 1, wherein the ring body is a C-shaped ring.

13. The force measurement apparatus, adapted to sense a radial deformation of a pile, according to claim 1, wherein the ring body comprises two arc-shaped structures.

14. The force measurement apparatus, adapted to sense a radial deformation of a pile, according to claim 1, wherein the force sensing element is a piezoelectric sensing element.

15. The force measurement apparatus, adapted to sense a radial deformation of a pile, according to claim 1, wherein the force sensors are axisymmetrically disposed on the inner surface of the ring body with respect to the axis.

16. A force measurement apparatus, adapted to sense a radial deformation of the pile, comprising:
at least one pressing ring comprising:
a ring body with at least one end and an inner surface, wherein the ring body surrounds an axis passing through a centroid of the ring body, the inner surface faces the pile; and
at least one pressing part disposed at the at least one end; and
at least one force sensor comprising:
a connection part connected to the inner surface of the ring body;
a contact part with a convex surface facing the pile, wherein the contact part is connected with the connection part to forms a space, the at least one pressing part is capable of pressing the ring body such that the convex surface contacts the pile to fix the at least one force sensor on the pile; and
a force sensing element disposed in the space to sense the radial deformation of the pile.

17. The force measurement apparatus, adapted to sense a radial deformation of a pile, according to claim 16, wherein a region where the convex surface contacts the pile is a plane.

18. The force measurement apparatus, adapted to sense a radial deformation of a pile, according to claim 16, wherein a region where the convex surface contacts the pile is a line.

19. A force measurement apparatus, adapted to sense a radial deformation of a pile, comprising:
at least one pressing ring comprising:
two arc-shaped structures, wherein the two arc-shaped structures surround an axis passing through a centroid of the two arc-shaped structures, each of the two arc-shaped structures has two ends and an inner surface facing the pile; and
a plurality of pressing parts, wherein each of the plurality of the pressing parts is connected with the corresponding one of the two ends; and
at least one force sensors comprising:
a connection part connected to the inner surface of one of the two arc-shaped structures;
a contact part having a convex surface facing the pile, wherein the contact part is connected with the connection part to form a space, a radial stiffness of the contact part is smaller than a radial stiffness of each of the arc-shaped structures; and
a force sensing element disposed in the space,
wherein a plurality of the pressing parts is capable of pressing the two arc-shaped structures such that the convex surface of the contact part contacts the pile to fix the force sensor on the pile for sensing the radial deformation of the pile, a region where the convex surface of the contact part contacts the pile is a plane or a line.

20. The force measurement apparatus, adapted to sense a radial deformation of a pile, according to claim 19, wherein a radial dimension of the contact part is smaller than a radial dimension of each of the arc-shaped structures.

21. The force measurement apparatus, adapted to sense a radial deformation of a pile, according to claim 20, wherein a radial dimension of the connection part is smaller than the radial dimension of each of the arc-shaped structures.

22. The force measurement apparatus, adapted to sense a radial deformation of a pile, according to claim 20, wherein the radial dimension of the contact part is smaller than a radial dimension of the connection part.

23. The force measurement apparatus, adapted to sense a radial deformation of a pile, according to claim 22, wherein the force sensing element is a piezoelectric sensing element, the piezoelectric sensing element comprises a piezoelectric sheet and a housing, a normal vector of the piezoelectric sheet faces the pile.

24. The force measurement apparatus, adapted to sense a radial deformation of a pile, according to claim 22, wherein the force sensors are axisymmetrically disposed on the inner surfaces of the two arc-shaped structures with respect to the axis.
